(19) United States
(12) Patent Application Publication
(10) Pub. No.: US 2023/0212414 A1
(43) Pub. Date: Jul. 6, 2023

(54) RESIN COMPOSITION, ANTI-ETCHING LAYER AND ETCHING METHOD

(71) Applicant: eChem Solutions Corp., Taoyuan (TW)

(72) Inventors: Yu-Ning Chen, Taoyuan (TW); Shao-Li Ho, Taoyuan (TW); Jia Jheng Lin, Taoyuan (TW); Hui-Ju Chen, Taoyuan (TW)

(73) Assignee: eChem Solutions Corp., Taoyuan (TW)

(21) Appl. No.: 18/090,522

(22) Filed: Dec. 29, 2022

(30) Foreign Application Priority Data
Jan. 4, 2022 (TW) 111100200

(51) Int. Cl. C09D 125/18; C09D 161/06; C09D 5/00; C09D 7/20; C09D 7/45; C09D 7/65; C09D 7/63

(52) U.S. Cl. CPC C09D 125/18; C09D 161/06; C09D 5/00; C09D 7/20; C09D 7/45; C09D 7/65; C09D 7/63

(57) ABSTRACT

A resin composition, an anti-etching layer and an etching method are provided. The resin composition includes a resin (A), a crosslinking agent (B), a surfactant (C), and a solvent (D). The resin (A) includes a hydroxyl type polystyrene resin (A-1), a hydroxyl type phenolic resin (A-2), a polyhydroxy phenol resin (A-3), or a combination thereof. The crosslinking agent (B) includes a structure of novolac epoxy resin type (B-1), polymethyl methacrylate type (B-2), maleimide type (B-3) or hyperbranched oligomer (B-4).

### CROSS-REFERENCE TO RELATED APPLICATION

This application claims the priority benefit of Taiwan application serial no. 111100200, filed on Jan. 4, 2022. The entirety of the above-mentioned patent application is hereby incorporated by reference herein and made a part of this specification.

### BACKGROUND

### Technical Field

The disclosure relates to a resin composition, and particularly relates to a resin composition for anti-etching layer, an anti-etching layer and an etching method.

### Description of Related Art

In recent years, with the high integration and refinement of semiconductor patterns, in order to obtain higher-resolution images, the thickness of the photoresist layer is gradually reduced. However, there exists the collapse phenomenon caused by the incomplete exposure of the photoresist and the difficulty of using a thinner photoresist layer to have sufficient etching selectivity to etch the layer to be etched. Therefore, under the current technology, an inorganic or organic layer with high etching resistance is prepared between the photoresist layer and the layer to be etched. The pattern on the photoresist is first transferred to the anti-etching layer, and then the patterned anti-etching layer is used to etch the layer to be etched, so the etching selectivity can be effectively improved by using this method.

The reticle pattern of the semiconductor industry has become finer, the line width has become narrower, and the height of the pattern has been relatively increased, resulting in an increase in aspect ratio and an increase in the height of the etched layer. Therefore, phenomena such as bowing may occur in etching, and when the selection ratio of etching conditions is different, it will also make it difficult to perform the function of the mask normally. As a result, in addition to reducing the standing wave effect, the current research direction also increases the overall etching selectivity by introducing an etching layer with better etching resistance.

### SUMMARY

The disclosure provides a resin composition, an anti-etching layer and an etching method, the resin composition can be used to prepare an etch resistant layer with high flatness and excellent chemical resistance, and patterning can be achieved by using the etching selectivity of this resin composition formulation and photoresist or substrate.

A resin composition according to the disclosure includes a resin (A), a crosslinking agent (B), a surfactant (C), and a solvent (D). The resin (A) includes a hydroxyl type polystyrene resin (A-1), a hydroxyl type phenolic resin (A-2), a polyhydroxy phenol resin (A-3), or a combination thereof. The crosslinking agent (B) includes a structure of novolac epoxy resin type (B-1), polymethyl methacrylate type (B-2), maleimide type (B-3) or hyperbranched oligomer (B-4).

The hydroxyl type polystyrene resin (A-1) includes a chemical structure represented by formula (A-1),

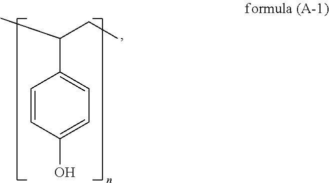

in formula (A-1), n is an integer greater than 103 and less than 160,

the hydroxyl type phenolic resin (A-2) includes a chemical structure represented by formula (A-2),

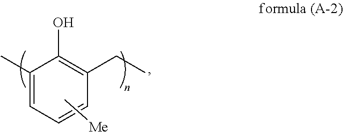

in formula (A-2), n is an integer greater than 35 and less than 168,

the polyhydroxy phenol resin (A-3) includes a chemical structure represented by formula (A-3),

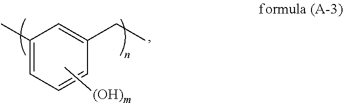

in formula (A-3), m is an integer of 4 or less, and n is an integer greater than 4 and less than 113.

In an embodiment of the disclosure, a molecular weight of the hydroxyl type polystyrene resin (A-1) is 12400 to 19300, a molecular weight of the hydroxyl type phenolic resin (A-2) is 4300 to 20200, and a molecular weight of the polyhydroxy phenol resin (A-3) is 600 to 12000.

In an embodiment of the disclosure, the novolac epoxy resin type (B-1) includes a bisphenol A novolac epoxy resin, a novolac epoxy resin or a cresol novolac epoxy resin.

In an embodiment of the disclosure, the novolac epoxy resin type (B-1) includes a compound represented by formula (B-1):

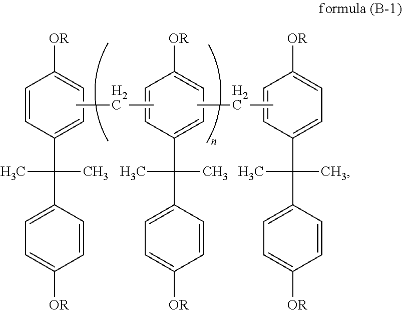

in formula (B-1), R is H or (OCH₂CH)CH₂—, and n is an integer greater than 10 and less than 45.

In an embodiment of the disclosure, the polymethyl methacrylate type (B-2) includes a structure represented by formula (B-2):

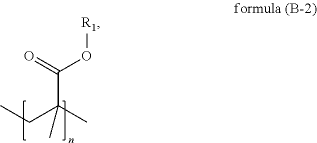

in formula (B-2), R₁ is an epoxy group, a benzene ring structure, an alkane structure, an alcohol structure or an ether structure, and n is an integer greater than 53 and less than 138.

In an embodiment of the disclosure, the maleimide type (B-3) includes a structure represented by formula (B-3):

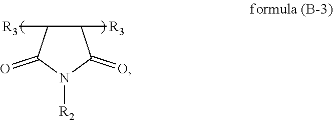

in formula (B-3), R₂ is a cyclohexane, a benzene ring structure, an alkane structure or a hydrogen, R₃ is a polyacrylic acid structure, a polystyrene structure, a maleic anhydride structure, an acrylic structure or a combination thereof.

In an embodiment of the disclosure, the hyperbranched oligomer (B-4) includes a structure represented by formula (B-4):

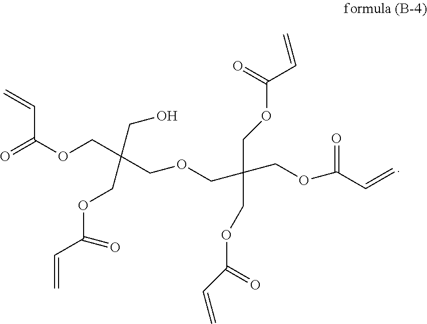 [SMILES: C=CC(=O)OCC(CO)(COCC(COC(=O)C=C)(COC(=O)C=C)COC(=O)C=C)COC(=O)C=C]

In an embodiment of the disclosure, based on a total weight of the resin composition, an added amount of the resin (A) is 0.45 wt % to 4.05 wt %.

In an embodiment of the disclosure, based on a total weight of the resin composition, an added amount of the resin (A) is 2.25 wt % to 3.375 wt %.

In an embodiment of the disclosure, based on a total weight of the resin composition, an added amount of the crosslinking agent (B) is 0.45 wt % to 4.05 wt %.

In an embodiment of the disclosure, based on a total weight of the resin composition, an added amount of the crosslinking agent (B) is 1.125 wt % to 2.25 wt %.

In an embodiment of the disclosure, a structure of the surfactant (C) includes alcohols, esters, acids having fluorine functional group or a combination thereof.

In an embodiment of the disclosure, the fluorine functional group includes a chemical structure represented by formula (C-1):

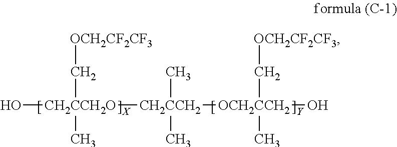

in formula (C-1), 6<x+y<20.

In an embodiment of the disclosure, based on a total weight of the resin composition, an added amount of the surfactant (C) is 0.01 wt % to 0.1 wt %.

In an embodiment of the disclosure, based on a total weight of the resin (A) and the crosslinking agent (B), an added amount of the resin (A) is 10% to 75%.

In an embodiment of the disclosure, the solvent (D) includes propylene glycol methyl ether acetate, propylene glycol methyl ether, isopropyl alcohol, methanol, acetone, n-butyl acetate, butanone, ethyl acetate, diacetone alcohol or a combination thereof.

An anti-etching layer, formed by the resin composition.

An etching method, including soaking the anti-etching layer in an etching solution, a film thickness loss of the anti-etching layer after soaking for 10 minutes is less than 10 Å.

Based on the above, the resin composition of the disclosure contains specific types of resin (A) and crosslinking agent (B). By selecting specific ratios and types of resin (A) and crosslinking agent (B), the chemical resistance properties can be directly affected. Therefore, an anti-etching layer with higher chemical resistance and better flatness can be prepared using this resin composition.

### DESCRIPTION OF THE EMBODIMENTS

Hereinafter, embodiments of the disclosure will be described in detail. However, these embodiments are illustrative, and the disclosure is not limited thereto.

In the present specification, a range represented by “a numerical value to another numerical value” is a schematic representation for avoiding listing all of the numerical values in the range in the specification. Therefore, the recitation of a specific numerical range covers any numerical value in the numerical range and a smaller numerical range defined by any numerical value in the numerical range, as is the case with any numerical value and a smaller numerical range thereof in the specification.

### Resin Composition

The disclosure provides a resin composition, including a resin (A), a crosslinking agent (B), a surfactant (C), and a solvent (D). Hereinafter, the above-mentioned components will be described in detail.

### Resin (A)

The resin (A) includes a hydroxyl type polystyrene resin (A-1), a hydroxyl type phenolic resin (A-2), a polyhydroxy phenol resin (A-3), or a combination thereof.

The hydroxyl type polystyrene resin (A-1) includes a chemical structure represented by formula (A-1),

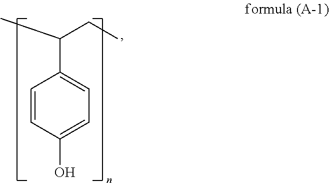

in formula (A-1), n is an integer greater than 103 and less than 160,

the hydroxyl type phenolic resin (A-2) includes a chemical structure represented by formula (A-2),

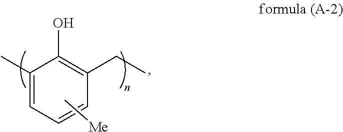

in formula (A-2), n is an integer greater than 35 and less than 168,

the polyhydroxy phenol resin (A-3) includes a chemical structure represented by formula (A-3),

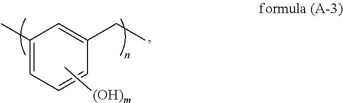

in formula (A-3), m is an integer of 4 or less, and n is an integer greater than 4 and less than 113.

The hydroxyl type phenolic resin (A-2) can make the formed anti-etching layer have excellent flatness. However, due to the position of the methyl group in the ortho, para or meta position, the partial charge strength of the affected hydroxyl group is different, resulting in a different reactivity with the secondary carbon on the crosslinking agent (B), resulting in the crosslinking ability difference. When the methyl group of hydroxyl type phenolic resin (A-2) is located in the ortho or para position, the partial charge density of the affected hydroxyl group is high, resulting in a strong reactivity with the secondary carbon on the crosslinking agent (B). Therefore, the cross-linking ability is better.

A molecular weight of the hydroxyl type polystyrene resin (A-1) is 12400 to 19300, a molecular weight of the hydroxyl type phenolic resin (A-2) is 4300 to 20200, and a molecular weight of the polyhydroxy phenol resin (A-3) is 600 to 12000.

Based on a total weight of the resin composition, an added amount of the resin (A) is 0.45 wt % to 4.05 wt %, preferably 2.25 wt % to 3.375 wt %.

As for the resin (A) in resin composition, the hydroxyl type polystyrene resin (A-1) can make the formed anti-etching layer have good flatness and chemical resistance, the hydroxyl type phenolic resin (A-2) can make the formed anti-etching layer can have excellent flatness, and the polyhydroxy phenol resin (A-3) can make the formed anti-etching layer have excellent chemical resistance.

### Crosslinking Agent (B)

The crosslinking agent (B) includes a structure of novolac epoxy resin type (B-1), polymethyl methacrylate type (B-2), maleimide type (B-3) or hyperbranched oligomer (B-4).

The novolac epoxy resin type (B-1) includes a bisphenol A novolac epoxy resin, a novolac epoxy resin or a cresol novolac epoxy resin.

The novolac epoxy resin type (B-1) preferably includes a compound represented by formula (B-1):

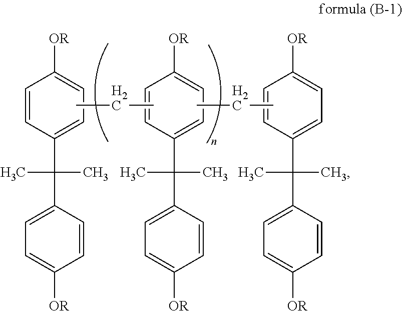

in formula (B-1), R is H or (OCH₂CH)CH₂—, and n is an integer greater than 10 and less than 45.

In the present embodiment, the novolac epoxy resin type (B-1) may include the structure shown in the following chemical formula:

bisphenol A novolac epoxy resin (10<n<45)

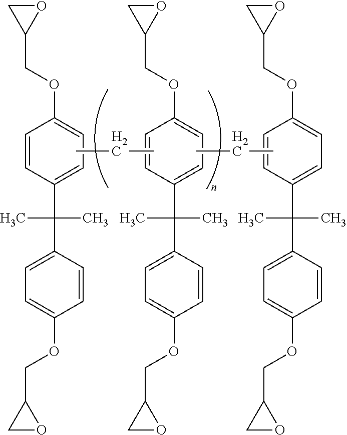

novolac epoxy resin (10<n<50)

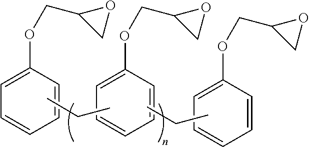

cresol novolac epoxy resin (10<n<50)

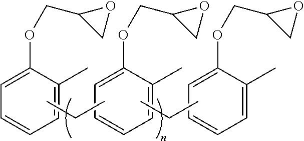

The polymethyl methacrylate type (B-2) includes a structure represented by formula

(B-2):

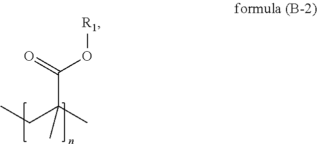

in formula (B-2), R₁ may be an epoxy group, a benzene ring structure, an alkane structure, an alcohol structure or an ether structure, and n is an integer greater than 53 and less than 138.

Besides, the polymethyl methacrylate type (B-2) preferably includes the structure shown in the following chemical formula:

polymethyl methacrylate resin (0<a<30 ; 40<b<70 ; 5<c<30)

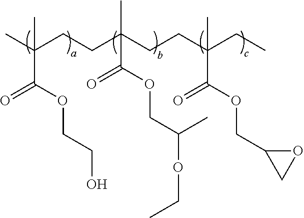

The maleimide type (B-3) includes a structure represented by formula (B-3):

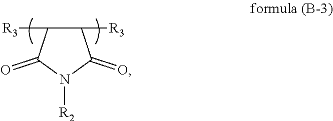

in formula (B-3), R₂ is a cyclohexane, a benzene ring structure, an alkane structure or a hydrogen, R₃ is a polyacrylic acid structure, a polystyrene structure, a maleic anhydride structure, an acrylic structure or a combination thereof

The hyperbranched oligomer (B-4) includes a structure represented by formula (B-4):

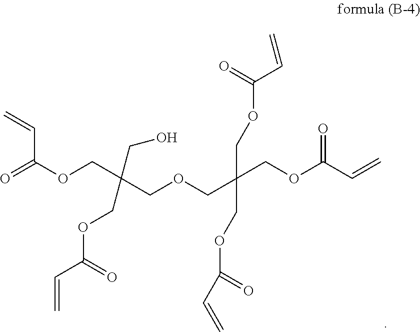 [SMILES: C=CC(=O)OCC(CO)(COCC(COC(=O)C=C)(COC(=O)C=C)COC(=O)C=C)COC(=O)C=C]

Based on a total weight of the resin composition, an added amount of the crosslinking agent (B) is 0.45 wt % to 4.05 wt %, preferably 1.125 wt % to 2.25 wt %. Based on a total weight of the resin (A) and the crosslinking agent (B), an added amount of the resin (A) is 10% to 75%. When the addition ratio of resin (A) is within this range, the formed anti-etching layer has excellent chemical resistance and flatness. However, based on the total weight of resin (A) and crosslinking agent (B), when the addition ratio of resin (A) is higher than 75%, the crosslinking agent (B) is added too little, the crosslinking structure of the formulation is not complete, so that the chemical resistance of the anti-etching layer is significantly reduced.

The function of the crosslinking agent (B) in the resin composition is to increase the crosslinking density of the cured product, so that the formed anti-etching layer has excellent chemical resistance and flatness.

### Surfactant (C)

The surfactant (C) includes alcohols, esters, acids having fluorine functional group or a combination thereof. The fluorine functional group includes a chemical structure represented by formula (C-1):

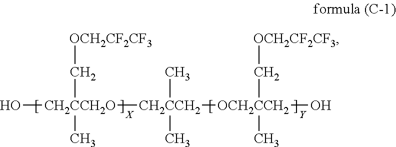

in formula (C-1), 6<x+y<20.

Based on a total weight of the resin composition, an added amount of the surfactant (C) is 0.01 wt % to 0.1 wt %.

The surfactant (C) is added to the resin composition, which will affect the back-end process, reduce the occurrence of uneven distribution of the film surface (Mura), and increase the flatness of the formulation. Without the addition of surfactant (C), the flatness is poor, and the addition of surfactant (C) can improve the flatness.

### Solvent (D)

The solvent (D) may include propylene glycol methyl ether acetate, propylene glycol methyl ether, isopropyl alcohol, methanol, acetone, n-butyl acetate, butanone, ethyl acetate, diacetone alcohol or a combination thereof.

Based on a total weight of the resin composition, the using amount of the solvent (D) is 90 wt % to 98 wt %.

The function of solvent (D) is to dissolve the solid component, and uniformly coat the solid component on the substrate by the fluidity of the liquid.

### Preparation Method of Resin Composition

The preparation method of the resin composition is not particularly limited. For example, the resin (A), the crosslinking agent (B), the surfactant (C) and the solvent (D) are placed in a mixer and stirred, and after mixing them uniformly, a liquid resin composition can be obtained.

### Manufacturing Method of Anti-Etching Layer

An exemplary embodiment of the disclosure provides an anti-etching layer formed using the above resin composition.

The resin composition is coated on the substrate and placed on a baking plate at 250° C. for 2 minutes to obtain an anti-etching layer.

The substrate may be a silicon substrate, a metal oxide layer or a metal nitride layer, and the type thereof is not particularly limited.

The coating method is not particularly limited, but a spray coating method, a roll coating method, a spin coating method, or the like can be used, and in general, a spin coating method is widely used.

### Etching Method

An exemplary embodiment of the disclosure provides a kind of etching method, the above-mentioned anti-etching layer is soaked in etching solution, and the etching solution is PM:PMA=7:3 (OK73) solution, for example. The film thickness loss of the anti-etching layer after soaking for 10 minutes is less than 10 Å.

Below, the present disclosure is described in detail hereinafter with reference to several examples. The following examples are provided to describe the present disclosure. The scope of the present disclosure includes the scope and its substitutions and modifications of the following claims, and it is not limited to the scope of the examples.

### Embodiment of Resin Composition and Anti-Etching Layer

Example A1 to Example A5, Example B1 to Example B5, Example C1 to Example C6, Example D1 to Example D5, Example E4 to Example E7, Comparative Example B6 and Comparative Example B7, Comparative Example C7, Comparative Example C8, Comparative Example D6 to Comparative Example D8 and Comparative Example E1 to Comparative Example E3 of resin composition and anti-etching layer are described below.

### EXAMPLE A1

### a. Resin Composition

The ingredient/compound corresponding to the label in the following Example A1 is as shown in the ingredient table. 3.15 wt % hydroxyl type polystyrene resin a-1 , 1.35 wt % novolac epoxy resin structure b-1, 0.1 wt % fluorine-based alcohol group-containing structure c-1 and 95.4 wt % PGMEA are uniformly stirred with a stirrer, and the resin composition of Example A1 is prepared.

### b. Anti-Etching Layer

The resin compositions prepared in the examples were coated on a silicon substrate by spin coating, and placed on a baking plate at 250° C. for 2 minutes, so as to obtain an anti-etching layer. The obtained anti-etching layer is evaluated by the following evaluation methods.

### REMAINING EXAMPLES AND COMPARATIVE EXAMPLES

The resin compositions of the remaining examples and comparative examples are prepared in the same steps as those of Example A1, and the difference lies in: changing the component types and usage amounts of the resin composition, and the label in the remaining examples and comparative examples are the corresponding ingredients/compounds are shown in the ingredient table. The obtained resin composition is made into an anti-etching layer and evaluated by the following evaluation methods.

[Ingredient table]

| | Label | Ingredient/compound |
|---|---|---|
| Resin (A) | a-1 | 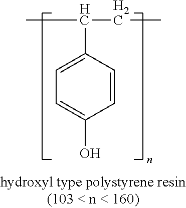 |
| | a-2 | 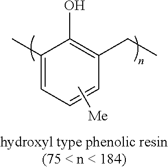 |
| | a-3 | 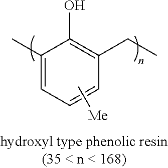 |
| | a-4 | 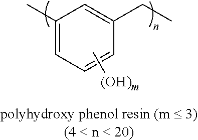 |
| | a-5 | 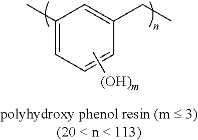 |
| Crosslinking agent (B) | b-1 | 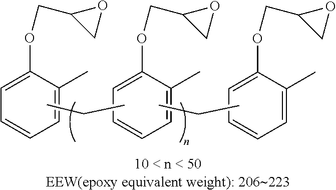 |
| | b-2 | 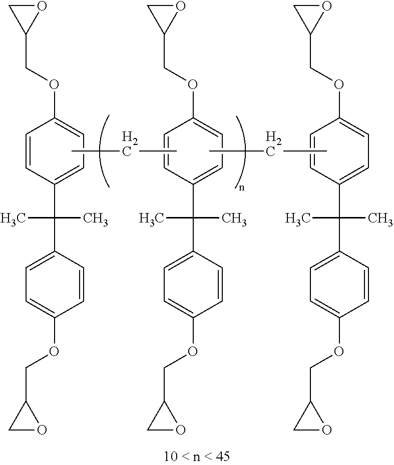 |
| | b-3 | 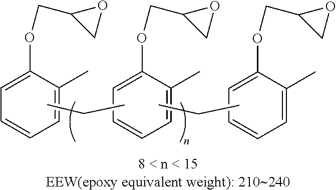 |
| | b-4 | 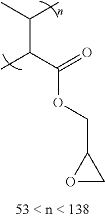 |
| | b-5 | 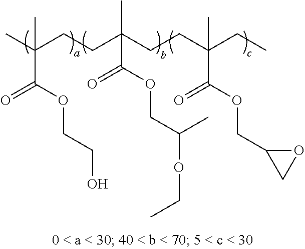 |
| | b-6 | 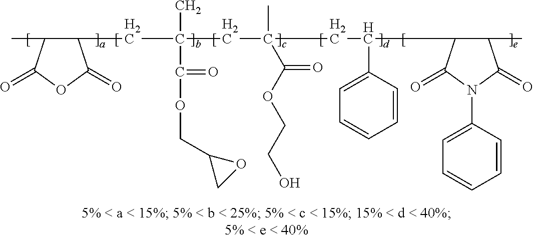 |
| | b-7 | 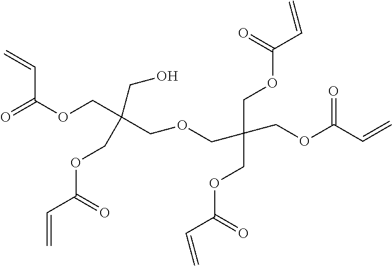 [SMILES: C=CC(=O)OCC(CO)(COCC(COC(=O)C=C)(COC(=O)C=C)COC(=O)C=C)COC(=O)C=C] |
| | b-8 | 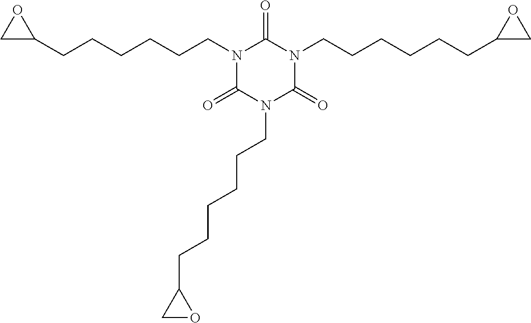 [SMILES: O=c1n(CCCCCCC2CO2)c(=O)n(CCCCCCC2CO2)c(=O)n1CCCCCCC1CO1] |
| Surfactant (C) | c-1 | 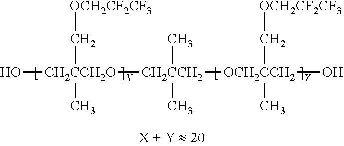 |
| | c-2 | 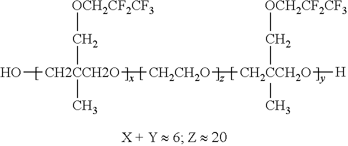 |
| | c-3 | 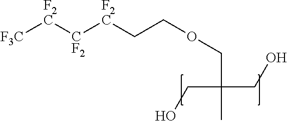 |
| | c-4 | 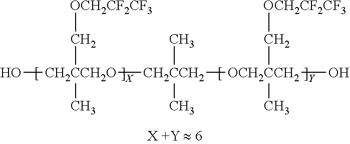 |
| | c-5 | Partially fluorinated alcohols substituted for ethylene glycol |
| | | (hexafluorocarbon) |
| | c-6 | Surfactant free of polysiloxanes |
| | c-7 | 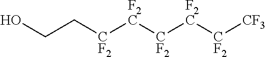 [SMILES: OCCC(F)(F)C(F)(F)C(F)(F)C(F)(F)C(F)(F)C(F)(F)F] |

### Evaluation Method

In terms of flatness, the resin compositions prepared in the examples and comparative examples are coated on an eight-inch silicon substrate, and the Cauchy parameters of the formulations are first detected by an ellipsometer, and then the parameters are set in the optical film thickness meter (DNS VM-1210), so as to detect the film thickness of 69 different points on the film surface and take the average film thickness and uniformity (flatness, that is, the thickest point minus the thinnest point).

In terms of chemical resistance, the resin compositions prepared in the examples and comparative examples are coated on an eight-inch silicon substrate, immersed in PM:PMA=7:3 (OK73) solution, and the changes in film thickness before and after immersion for 10 minutes is measured. As for the evaluation criteria, the examples must satisfy the flatness below 40 Å and the film thickness variation within 10 Å; otherwise it is the comparative example.

In terms of resistance to wet etching, the resin compositions prepared in the examples and comparative examples are first coated on an eight-inch silicon substrate, and immersed in concentrated etching solutions of SC1 and SC2. The film thickness loss before and after immersion for 10 minutes is measured. As for the evaluation criteria, the examples must meet the film thickness loss within 30 Å; otherwise it is the comparative example. SC1(NH₄OH 29%:H₂O₂ 35%:H₂O=1:1:5); SC2(HCl 37%:H₂O₂ 35%:H₂O=1:1:5)

TABLE 1

| | | | Crosslinking | | | | | |
|---|---|---|---|---|---|---|---|---|
| | Resin (A) | | agent (B) | | Surfactant (C) | | Solvent (D) | |
| | | Ratio | | Ratio | | Ratio | | Ratio |
| Example | Name | (wt %) | Name | (wt %) | Name | (wt %) | Name | (wt %) |
| A1 | Hydroxyl | 3.15 | Novolac | 1.35 | Fluorine-based | 0.1 | PGMEA | 95.4 |
| | type | | epoxy resin | | alcohol | | | |
| | polystyrene | | structure b-1 | | containing | | | |
| | resin a-1 | | | | structure c-1 | | | |
| A2 | Hydroxyl | 3.15 | Novolac | 1.35 | Fluorine-based | 0.1 | PGMEA | 95.4 |
| | type | | epoxy resin | | alcohol | | | |
| | phenolic | | structure b-1 | | containing | | | |
| | resin a-2 | | | | structure c-1 | | | |
| A3 | Hydroxyl | 3.15 | Novolac | 1.35 | Fluorine-based | 0.1 | PGMEA | 95.4 |
| | type | | epoxy resin | | alcohol | | | |
| | phenolic | | structure b-1 | | containing | | | |
| | resin a-3 | | | | structure c-1 | | | |
| A4 | Polyhydroxy | 3.15 | Novolac | 1.35 | Fluorine-based | 0.1 | PGMEA | 95.4 |
| | phenol resin | | epoxy resin | | alcohol | | | |
| | a-4 | | structure b-1 | | containing | | | |
| | | | | | structure c-1 | | | |
| A5 | Polyhydroxy | 3.15 | Novolac | 1.35 | Fluorine-based | 0.1 | PGMEA | 95.4 |
| | phenol resin | | epoxy resin | | alcohol | | | |
| | a-5 | | structure b-1 | | containing | | | |
| | | | | | structure c-1 | | | |

The used composition type and usage amount of Example A1 to Example A5 are listed in Table 1. The structure of resin (A) in the resin composition formulation will affect the adhesion between the etching layer and the substrate or metal layer and the chemical resistance characteristics. The resin (A) used in the disclosure includes hydroxyl type polystyrene resin (A-1), hydroxyl type phenolic resin (A-2), polyhydroxy phenol resin (A-3) or a combination thereof.

As shown in table 1, the resin (A) of different structures and the same crosslinking agent (B) (novolac epoxy resin type (B-1)), the same surfactant (C) (fluorine-based alcohol-containing group surfactant) and the same solvent (D) (PGMEA) are prepared as the formulation. The resin composition is coated on the surface of the silicon substrate by spin coating, and then the flatness and chemical resistance immersion tests are carried out. The results are listed in Table 2.

TABLE 2

| Example | Flatness (Å) | Film thickness loss (Å) |
|---|---|---|
| A1 | 14.0 | 7.3 |
| A2 | 10.0 | 7.7 |
| A3 | 20.0 | −0.9 |
| A4 | 18.0 | 0.3 |
| A5 | 23.0 | −2.0 |

It can be seen from Table 2 that Example A1 using hydroxyl type polystyrene resin (A-1) has good flatness and chemical resistance. The resin composition using hydroxyl type phenolic resin (A-2) has excellent flatness, but due to the position of the methyl group in the para position or the meta position, the partial charge intensity of the affected hydroxyl group above is different, which causes different reactivity with the secondary carbon on the crosslinking agent, resulting in a difference in crosslinking ability (Example A2, Example A3). Example A4 and Example A5 using polyhydroxy phenol resin (A-3) have excellent chemical resistance.

TABLE 3

| | | | Crosslinking | | | | | |
|---|---|---|---|---|---|---|---|---|
| | Resin (A) | | agent (B) | | Surfactant (C) | | Solvent (D) | |
| | | Ratio | | Ratio | | Ratio | | Ratio |
| | Name | (wt %) | Name | (wt %) | Name | (wt %) | Name | (wt %) |
| Example B1 | Polyhydroxy | 3.60 | Novolac | 0.90 | Fluorine-based | 0.1 | PGMEA | 95.4 |
| | phenol resin a-5 | | epoxy resin | | alcohol containing | | | |
| | | | structure b-2 | | structure c-1 | | | |
| Example B2 | Polyhydroxy | 3.15 | Novolac | 1.35 | Fluorine-based | 0.1 | PGMEA | 95.4 |
| | phenol resin a-5 | | epoxy resin | | alcohol containing | | | |
| | | | structure b-2 | | structure c-1 | | | |
| Example B3 | Polyhydroxy | 2.70 | Novolac | 1.80 | Fluorine-based | 0.1 | PGMEA | 95.4 |
| | phenol resin a-5 | | epoxy resin | | alcohol containing | | | |
| | | | structure b-2 | | structure c-1 | | | |
| Example B4 | Polyhydroxy | 2.25 | Novolac | 2.25 | Fluorine-based | 0.1 | PGMEA | 95.4 |
| | phenol resin a-5 | | epoxy resin | | alcohol containing | | | |
| | | | structure b-2 | | structure c-1 | | | |
| Example B5 | Polyhydroxy | 1.80 | Novolac | 2.70 | Fluorine-based | 0.1 | PGMEA | 95.4 |
| | phenol resin a-5 | | epoxy resin | | alcohol containing | | | |
| | | | structure b-2 | | structure c-1 | | | |
| Comparative | Polyhydroxy | 4.05 | Novolac | 0.45 | Fluorine-based | 0.1 | PGMEA | 95.4 |
| Example B6 | phenol resin a-5 | | epoxy resin | | alcohol containing | | | |
| | | | structure b-2 | | structure c-1 | | | |
| Comparative | Polyhydroxy | 4.50 | X | 0 | Fluorine-based | 0.1 | PGMEA | 95.4 |
| Example B7 | phenol resin a-5 | | | | alcohol containing | | | |
| | | | | | structure c-1 | | | |

As shown in Table 3, in order to explore the formulation ratio of resin (A) and crosslinking agent (B), polyhydroxy phenol resin (A-3) with excellent chemical resistance and crosslinking agent (B) novolac epoxy resin type (B-1) are selected, and resin compositions are prepared in different ratios with the same surfactant (C) (fluorine-based alcohol group-containing surfactant) and the same solvent (D) (PGMEA). The resin composition is coated on the silicon substrate by spin coating, and then the flatness and chemical resistance tests are carried out.

The results are shown in Table 4.

TABLE 4

| | Flatness (Å) | Film thickness loss (Å) |
|---|---|---|
| Example B1 | 17.0 | −2.9 |
| Example B2 | 18.0 | −2.2 |
| Example B3 | 20.0 | −2.1 |
| Example B4 | 17.0 | −1.5 |
| Example B5 | 13.0 | 0.4 |
| Comparative Example B6 | 34.0 | 12.6 |
| Comparative Example B7 | 21.0 | 118.1 |

As shown in Table 4, based on the total weight of resin (A) and crosslinking agent (B), when the addition ratio of resin (A) is 10% to 75%, it has more excellent chemical resistance properties and flatness (Example B1 to Example B5). However, when the resin (A) is added at a ratio of more than 80% (Comparative Example B6 and Comparative Example B7), due to the addition of too little or no crosslinking agent, the resin composition crosslinking structure is incomplete, which makes the chemical resistance characteristic obviously decline.

TABLE 5

| | | | Crosslinking | | | | | |
|---|---|---|---|---|---|---|---|---|
| | Resin (A) | | agent (B) | | Surfactant (C) | | Solvent (D) | |
| | | Ratio | | Ratio | | Ratio | | Ratio |
| | Name | (wt %) | Name | (wt %) | Name | (wt %) | Name | (wt %) |
| Example C1 | Polyhydroxy | 3.15 | Novolac epoxy | 1.35 | Fluorine-based | 0.1 | PGMEA | 95.4 |
| | phenol resin a-4 | | resin structure | | alcohol | | | |
| | | | b-1 | | containing | | | |
| | | | | | structure c-1 | | | |
| Example C2 | polyhydroxy | 3.15 | Novolac epoxy | 1.35 | Fluorine-based | 0.1 | PGMEA | 95.4 |
| | phenol resin a-4 | | resin structure | | alcohol | | | |
| | | | b-3 | | containing | | | |
| | | | | | structure c-1 | | | |
| Example C3 | polyhydroxy | 3.15 | Acrylic | 1.35 | Fluorine-based | 0.1 | PGMEA | 95.4 |
| | phenol resin a-4 | | structure | | alcohol | | | |
| | | | b-4 | | containing | | | |
| | | | | | structure c-1 | | | |
| Example C4 | polyhydroxy | 3.15 | Acrylic | 1.35 | Fluorine-based | 0.1 | PGMEA | 95.4 |
| | phenol resin a-4 | | structure | | alcohol | | | |
| | | | b-5 | | containing | | | |
| | | | | | structure c-1 | | | |
| Example C5 | polyhydroxy | 3.15 | Novolac epoxy | 1.35 | Fluorine-based | 0.1 | PGMEA | 95.4 |
| | phenol resin a-4 | | resin structure | | alcohol | | | |
| | | | b-2 | | containing | | | |
| | | | | | structure c-1 | | | |
| Example C6 | polyhydroxy | 3.15 | Maleimide | 1.35 | Fluorine-based | 0.1 | PGMEA | 95.4 |
| | phenol resin a-4 | | structure | | alcohol | | | |
| | | | b-6 | | containing | | | |
| | | | | | structure c-1 | | | |
| Comparative | polyhydroxy | 3.15 | Hyperbranched | 1.35 | Fluorine-based | 0.1 | PGMEA | 95.4 |
| Example C7 | phenol resin a-4 | | oligomer | | alcohol | | | |
| | | | b-7 | | containing | | | |
| | | | | | structure c-1 | | | |
| Comparative | polyhydroxy | 3.15 | Melamine | 1.35 | Fluorine-based | 0.1 | PGMEA | 95.4 |
| Example C8 | phenol resin a-4 | | structure | | alcohol | | | |
| | | | b-8 | | containing | | | |
| | | | | | structure c-1 | | | |

The degree and density of crosslinking directly affects the chemical resistance of the resin composition. As shown in Table 5, in order to understand the effect of different structures of crosslinking agent (B) on resin composition, the polyhydroxy phenol resin (A-3) with excellent chemical resistance and different crosslinking agent (B) (novolac epoxy resin type, polymethyl methacrylate type, hyperbranched urethane type oligomer type, melamine type, maleimide type structure) are selected for formulation, with the same surfactant (C) (fluorine-based alcohol-containing surfactant) and the same solvent (D) (PGMEA), to prepare the resin composition. The formulation resin composition is coated on the surface of the silicon substrate by spin coating, and then the flatness and chemical resistance immersion tests are performed. The results are listed in Table 6.

TABLE 6

| | Flatness (Å) | Film thickness loss (Å) |
|---|---|---|
| Example C1 | 18.0 | 0.3 |
| Example C2 | 27.0 | −1.1 |
| Example C3 | 14.0 | −0.7 |
| Example C4 | 38.0 | −0.2 |
| Example C5 | 34.0 | −2.5 |
| Example C6 | 37.0 | −5.1 |
| Comparative Example C7 | 22.0 | −74.1 |
| Comparative Example C8 | 76.0 | −2.8 |

As shown in Table 6, when the crosslinking agent (B) of the structure of novolac epoxy resin type (B-1), polymethyl methacrylate type (B-2) or maleimide type (B-3) of the disclosure is added (Example C1 to Example C6), the cured product has high cross-linking density, excellent chemical resistance and flatness. In contrast, the Comparative Example C7 added with a hyperbranched crosslinking agent has good flatness, but it is not easy for its branched network structure to form a dense crosslinking structure, which makes it have poor chemical resistance. Comparative Example C8 added with a melamine structure crosslinking agent has good chemical resistance, but the flatness is poor.

TABLE 7

| | | | Crosslinking | | | | | |
|---|---|---|---|---|---|---|---|---|
| | Resin (A) | | agent (B) | | Surfactant (C) | | Solvent (D) | |
| | | Ratio | | Ratio | | Ratio | | Ratio |
| | Name | (wt %) | Name | (wt %) | Name | (wt %) | Name | (wt %) |
| Example D1 | Polyhydroxy | 2.70 | Novolac | 1.80 | Fluorine-based | 0.1 | PGMEA | 95.4 |
| | phenol resin a-5 | | epoxy resin | | surfactant | | | |
| | | | structure | | c-1 | | | |
| | | | b-3 | | | | | |
| Example D2 | Polyhydroxy | 2.70 | Novolac | 1.80 | Fluorine-based | 0.1 | PGMEA | 95.4 |
| | phenol resin a-5 | | epoxy resin | | surfactant | | | |
| | | | structure | | c-5 | | | |
| | | | b-3 | | | | | |
| Example D3 | Polyhydroxy | 2.70 | Novolac | 1.80 | Fluorine-based | 0.1 | PGMEA | 95.4 |
| | phenol resin a-5 | | epoxy resin | | surfactant | | | |
| | | | structure | | c-3 | | | |
| | | | b-3 | | | | | |
| Example D4 | Polyhydroxy | 2.70 | Novolac | 1.80 | Fluorine-based | 0.1 | PGMEA | 95.4 |
| | phenol resin a-5 | | epoxy resin | | surfactant | | | |
| | | | structure | | c-6 | | | |
| | | | b-3 | | | | | |
| Example D5 | Polyhydroxy | 2.70 | Novolac | 1.80 | Fluorine-based | 0.1 | PGMEA | 95.4 |
| | phenol resin a-5 | | epoxy resin | | surfactant | | | |
| | | | structure | | c-7 | | | |
| | | | b-3 | | | | | |
| Comparative | Polyhydroxy | 2.70 | Novolac | 1.80 | X | 0.0 | PGMEA | 95.5 |
| Example | phenol resin a-5 | | epoxy resin | | | | | |
| D6 | | | structure | | | | | |
| | | | b-3 | | | | | |
| Comparative | Polyhydroxy | 2.70 | Novolac | 1.80 | Fluorine-based | 0.1 | PGMEA | 95.4 |
| Example | phenol resin a-5 | | epoxy resin | | surfactant | | | |
| D7 | | | structure | | c-2 | | | |
| | | | b-3 | | | | | |
| Comparative | Polyhydroxy | 2.70 | Novolac | 1.80 | [symbol] surfactant | 0.1 | PGMEA | 95.4 |
| Example | phenol resin a-5 | | epoxy resin | | c-4 | | | |
| D8 | | | structure | | | | | |
| | | | b-3 | | | | | |

As shown in Table 7, experiments are conducted on the effect of fluorine-based surfactants of different structures on resin composition. Due to the better hydrophobicity of fluorine-based surfactants, the same resin (A)—polyhydroxy phenol resin (A-3), the same crosslinking agent (B)—novolac epoxy resin structure crosslinking agent and the same solvent (D) (PGMEA) are used to prepare the resin composition. The formulation resin composition is coated on the surface of the silicon substrate by spin coating, and then the flatness and chemical resistance immersion tests are performed. The results are listed in Table 8.

TABLE 8

| | Flatness (Å) | Film thickness loss (Å) |
|---|---|---|
| Example D1 | 30.0 | −0.9 |
| Example D2 | 23.0 | 2.4 |
| Example D3 | 20.0 | −2.4 |
| Example D4 | 28.0 | −3.1 |
| Example D5 | 31.0 | 6.0 |
| Comparative Example D6 | 64.0 | 2.8 |
| Comparative Example D7 | 58.0 | −6.7 |
| Comparative Example D8 | 44.0 | 14.4 |

As shown in Table 8, the addition of surfactant (C) can affect the back-end process, reduce the occurrence of film uneven distribution (Mura) and increase flatness. In Comparative Example D6, it is found that surfactant (C) is not added and the flatness is poor. In contrast, Examples D1 to D5 with surfactant (C) added have improved flatness. However, as in Comparative Example D7 and Comparative Example D8, due to the difference in the number of fluorine-based functional group structures contained in different fluorine-based surfactants, the reactions involved in the formulation are different, resulting in a slight difference in chemical resistance.

Table 9 is the test value table of the example and comparative example in wet etching with different composition formulation. As shown in Table 9, in Example A1, Example A3 and Example A4 with different types of resin added, it can be seen that hydroxyl type polystyrene resin, hydroxyl type phenolic resin and polyhydroxy phenol resin all have excellent wet etching resistance. In Example A4, Example C3, and Comparative Example C7 with different types of crosslinking agents added, the crosslinking agents in Example A4 and Example C3 contain epoxy groups, which form dense crosslinking structures when crosslinked by heat, so they have better etching resistance. Comparative Example C7 adopts a branched network structure, which is not easy to form a dense cross-linked structure, so it has poor wet etching resistance. From Table 9, it can be known that the resin composition of the disclosure has better resistance to acid corrosion. In Table 9, Solution Condition 1 is (NH₄OH 29%:H₂O₂ 35%:H₂O=1:1:5); SC2 is (HCl 37%:H₂O₂ 35%:H₂O=1:1:5).

TABLE 9

| | Wet etching | Wet etching |
|---|---|---|
| | resistance SC1(Å) | resistance SC2(Å) |
| Example A1 | 19.4 | 1.7 |
| Example A3 | 6.0 | 2.5 |
| Example A4 | 21.7 | 12.9 |
| Example C3 | 26 | −4.2 |
| Comparative Example C7 | −186.6 | 5.0 |

Due to the ratio of resin and crosslinking agent in the solid content, the wet etching resistance property can be directly affected. Therefore, further wet etching tests are performed for different content formulation ratios. Table 10 is the ingredient table of Example E4 to Example E7 and Comparative Example E1 to Comparative Example E3 with different resin (A) and crosslinking agent (B), and Table 11 is a test value table of Example E4 to Example E7 and Comparative Example E1 to Comparative Example E3 in wet etching with different ingredient ratio formulations. As shown in Table 11, when the addition amount of the crosslinking agent is less than 1.125%, the etching resistance characteristic is obviously decreased due to the little content of the crosslinking agent.

TABLE 10

| | | | Crosslinking | | | | | |
|---|---|---|---|---|---|---|---|---|
| | Resin (A) | | agent (B) | | Surfactant (C) | | Solvent (D) | |
| | | Ratio | | Ratio | | Ratio | | Ratio |
| | Name | (wt %) | Name | (wt %) | Name | (wt %) | Name | (wt %) |
| Comparative | Polyhydroxy | 4.05 | Novolac | 0.45 | Fluorine-based | 0.1 | PGMEA | 95.4 |
| Example E1 | phenol resin a-4 | | epoxy resin | | alcohol containing | | | |
| | | | structure b-3 | | structure | | | |
| | | | | | c-1 | | | |
| Comparative | Polyhydroxy | 3.825 | Novolac | 0.675 | Fluorine-based | 0.1 | PGMEA | 95.4 |
| Example E2 | phenol resin a-4 | | epoxy resin | | alcohol containing | | | |
| | | | structure b-3 | | structure | | | |
| | | | | | c-1 | | | |
| Comparative | Polyhydroxy | 3.60 | Novolac | 0.90 | Fluorine-based | 0.1 | PGMEA | 95.4 |
| Example E3 | phenol resin a-4 | | epoxy resin | | alcohol containing | | | |
| | | | structure b-3 | | structure | | | |
| | | | | | c-1 | | | |
| Example E4 | Polyhydroxy | 3.375 | Novolac | 1.125 | Fluorine-based | 0.1 | PGMEA | 95.4 |
| | phenol resin a-4 | | epoxy resin | | alcohol containing | | | |
| | | | structure b-3 | | structure | | | |
| | | | | | c-1 | | | |
| Example E5 | Polyhydroxy | 3.15 | Novolac | 1.35 | Fluorine-based | 0.1 | PGMEA | 95.4 |
| | phenol resin a-4 | | epoxy resin | | alcohol containing | | | |
| | | | structure b-3 | | structure | | | |
| | | | | | c-1 | | | |
| Example E6 | Polyhydroxy | 2.25 | Novolac | 2.25 | Fluorine-based | 0.1 | PGMEA | 95.5 |
| | phenol resin a-4 | | epoxy resin | | alcohol containing | | | |
| | | | structure b-3 | | structure | | | |
| | | | | | c-1 | | | |
| Example E7 | Polyhydroxy | 0.45 | Novolac | 4.05 | Fluorine-based | 0.1 | PGMEA | 95.4 |
| | phenol resin a-4 | | epoxy resin | | alcohol containing | | | |
| | | | structure b-3 | | structure | | | |
| | | | | | c-1 | | | |

TABLE 11

| | Wet etching | Wet etching |
|---|---|---|
| | resistance SC1(Å) | resistance SC2(Å) |
| Comparative Example E1 | 164.3 | 31.2 |
| Comparative Example E2 | 134.2 | 22.2 |
| Comparative Example E3 | 116.6 | 15.7 |
| Example E4 | 28.2 | 13.6 |
| Example E5 | 20.0 | 12.9 |
| Example E6 | 4.6 | 5.6 |
| Example E7 | 1.7 | 1.9 |

To sum up, the resin composition of the disclosure contains a specific type of resin (A) and a crosslinking agent (B). By selecting a specific ratio and type of resin (A) and crosslinking agent (B), it can directly affect the chemical resistance. Therefore, the resin composition can be used to prepare an anti-etching layer with higher chemical resistance and better flatness. Due to the addition of a specific kind of resin (A), the formed anti-etching layer has good flatness and chemical resistance. The crosslinking agent (B) can increase the crosslinking density of the cured product. As a result, the anti-etching layer formed has excellent chemical resistance and flatness. On the other hand, the addition of surfactant (C) resulted in improvement in flatness. In this way, the etching selectivity of the resin composition formulation and the photoresist or the substrate can be used to achieve the purpose of patterning.

What is claimed is:

1. A resin composition, comprising:
a resin (A) comprising a hydroxyl type polystyrene resin (A-1), a hydroxyl type phenolic resin (A-2), a polyhydroxy phenol resin (A-3), or a combination thereof;
a crosslinking agent (B) comprising a structure of novolac epoxy resin type (B-1), polymethyl methacrylate type (B-2), maleimide type (B-3) or hyperbranched oligomer (B-4);
a surfactant (C); and
a solvent (D),
wherein the hydroxyl type polystyrene resin (A-1) comprises a chemical structure represented by formula (A-1), 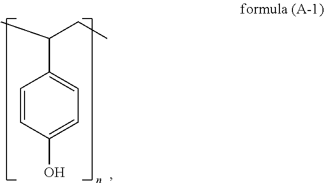
in formula (A-1), n is an integer greater than 103 and less than 160,
the hydroxyl type phenolic resin (A-2) comprises a chemical structure represented by formula (A-2), 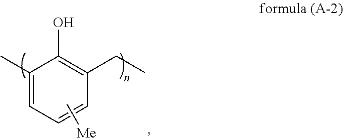
in formula (A-2), n is an integer greater than 35 and less than 168,
the polyhydroxy phenol resin (A-3) comprises a chemical structure represented by formula (A-3), 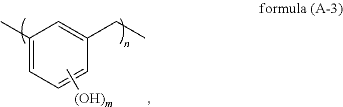
in formula (A-3), m is an integer of 4 or less, and n is an integer greater than 4 and less than 113.

2. The resin composition according to claim 1, wherein a molecular weight of the hydroxyl type polystyrene resin (A-1) is 12400 to 19300, a molecular weight of the hydroxyl type phenolic resin (A-2) is 4300 to 20200, and a molecular weight of the polyhydroxy phenol resin (A-3) is 600 to 12000.

3. The resin composition according to claim 1, wherein the novolac epoxy resin type (B-1) comprises a bisphenol A novolac epoxy resin, a novolac epoxy resin or a cresol novolac epoxy resin.

4. The resin composition according to claim 3, wherein the novolac epoxy resin type (B-1) comprises a compound represented by formula (B-1): 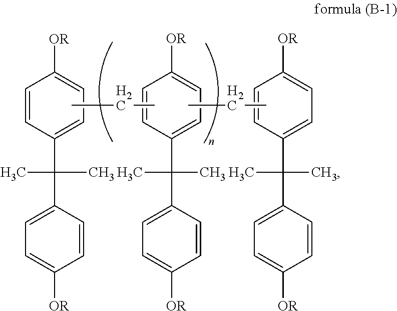
in formula (B-1), R is H or (OCH₂CH)CH₂—, and n is an integer greater than 10 and less than 45.

5. The resin composition according to claim 1, wherein the polymethyl methacrylate type (B-2) comprises a structure represented by formula (B-2): 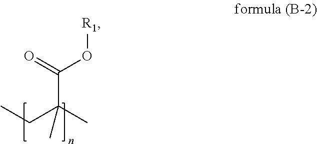
in formula (B-2), R₁ is an epoxy group, a benzene ring structure, an alkane structure, an alcohol structure or an ether structure, and n is an integer greater than 53 and less than 138.

6. The resin composition according to claim 1, wherein the maleimide type (B-3) comprises a structure represented by formula (B-3): 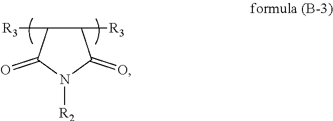
in formula (B-3), R₂ is a cyclohexane, a benzene ring structure, an alkane structure or a hydrogen, R₃ is a polyacrylic acid structure, a polystyrene structure, a maleic anhydride structure, an acrylic structure or a combination thereof.

7. The resin composition according to claim 1, wherein the hyperbranched oligomer (B-4) comprises a structure represented by formula (B-4):

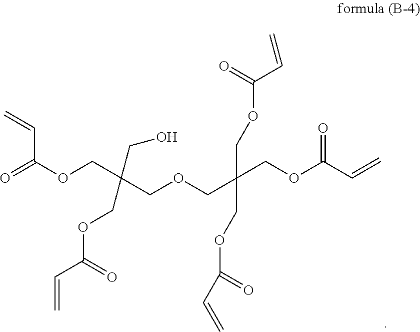 [SMILES: C=CC(=O)OCC(CO)(COCC(COC(=O)C=C)(COC(=O)C=C)COC(=O)C=C)COC(=O)C=C]

8. The resin composition according to claim 1, wherein based on a total weight of the resin composition, an added amount of the resin (A) is 0.45 wt % to 4.05 wt %.

9. The resin composition according to claim 8, wherein based on a total weight of the resin composition, an added amount of the resin (A) is 2.25 wt % to 3.375 wt %.

10. The resin composition according to claim 1, wherein based on a total weight of the resin composition, an added amount of the crosslinking agent (B) is 0.45 wt % to 4.05 wt %.

11. The resin composition according to claim 10, wherein based on a total weight of the resin composition, an added amount of the crosslinking agent (B) is 1.125 wt % to 2.25 wt %.

12. The resin composition according to claim 1, wherein a structure of the surfactant (C) comprises alcohols, esters, acids having fluorine functional group or a combination thereof.

13. The resin composition according to claim 12, wherein the fluorine functional group comprises a chemical structure represented by formula (C-1): 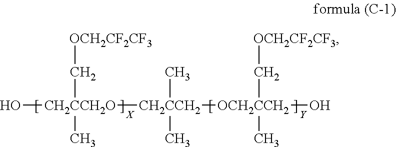
in formula (C-1), 6<x+y<20.

14. The resin composition according to claim 1, wherein based on a total weight of the resin composition, an added amount of the surfactant (C) is 0.01 wt % to 0.1 wt %.

15. The resin composition according to claim 1, wherein based on a total weight of the resin (A) and the crosslinking agent (B), an added amount of the resin (A) is 10% to 75%.

16. The resin composition according to claim 1, wherein the solvent (D) comprises propylene glycol methyl ether acetate, propylene glycol methyl ether, isopropyl alcohol, methanol, acetone, n-butyl acetate, butanone, ethyl acetate, diacetone alcohol or a combination thereof.

17. An anti-etching layer, formed by the resin composition according to claim 1.

18. An etching method, compirisng soaking the anti-etching layer according to claim 17 in an etching solution, a film thickness loss of the anti-etching layer after soaking for 10 minutes is less than 10 Å.
